(19) United States
(12) Patent Application Publication
(10) Pub. No.: US 2026/0167281 A1
(43) Pub. Date: Jun. 18, 2026

(54) AUTOMATIC SHIFTING COUNTERWEIGHT SYSTEM

(71) Applicant: Textron Inc., Providence, RI (US)

(72) Inventors: Brian David Wanta, North Augusta, SC (US); Christopher Kenneth Furman, Evans, GA (US)

(73) Assignee: Textron Inc., Providence, RI (US)

(21) Appl. No.: 18/978,753

(22) Filed: Dec. 12, 2024

(51) Int. Cl. B62D 49/08

(52) U.S. Cl. CPC B62D 49/085

(57) ABSTRACT

A stability system for a vehicle includes a track system, a counterweight, and an actuator. The track system is configured to couple to the vehicle. The counterweight is configured to couple to the track system. The actuator is configured to manipulate at least one of the counterweight or the track system to reposition the counterweight. The stability system also includes a non-transitory computer-readable medium having instructions stored thereon that, when executed by one or more processors, cause the one or more processors to acquire telemetry data from an inertial measurement unit (IMU) for the vehicle, determine an angle of operation of the vehicle based on the telemetry data, and control the actuator to adjust a position of the counterweight based on the angle of operation of the vehicle to increase stability.

### BACKGROUND

Golf courses are known for using the natural undulation of the land on which they are built to create the layout for their holes. Such undulations are deemed key features of the course and provide golfers with risk/reward opportunities during a round of golf. Also with these undulations, however, come dangerous terrain on which golf fleet vehicles and mowers are required to operate. If operators are not cautious, vehicles may roll over due to the slope of the terrain.

### SUMMARY

One embodiment relates to a golf vehicle. The golf vehicle includes a chassis, a plurality of tractive assemblies coupled to the chassis, a prime mover, an inertial measurement unit (IMU), a stability system, and a control system. The prime mover is configured to drive one or more of the plurality of tractive assemblies. The stability system includes a track system coupled to the chassis, a counterweight coupled to the track system, and an actuator configured to manipulate at least one of the counterweight or the track system to reposition the counterweight. The control system is configured to acquire telemetry data from the IMU, determine an angle of operation of the golf vehicle based on the telemetry data, and control the actuator to adjust a position of the counterweight based on the angle of operation of the golf vehicle to increase stability.

Another embodiment relates to a stability system for a vehicle. The stability system includes a track system configured to couple to the vehicle, a counterweight coupled to the track system, an actuator configured to manipulate at least one of the counterweight or the track system to reposition the counterweight, and a non-transitory computer-readable medium having instructions stored thereon. The instructions, when executed by one or more processors, cause the one or more processors to acquire telemetry data from an inertial measurement unit (IMU) for the vehicle, determine an angle of operation of the vehicle based on the telemetry data, and control the actuator to adjust a position of the counterweight based on the angle of operation of the vehicle to increase stability.

Still another embodiment relates to a method. The method includes acquiring telemetry data from an inertial measurement unit (IMU) of a vehicle, determining an angle of operation of the vehicle based on the telemetry data, and controlling an actuator to adjust a position of a counterweight of the vehicle based on the angle of operation of the vehicle to counteract a tipping moment resulting from the angle of operation.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1 including a counterweight system, according to an exemplary embodiment.

FIG. 3A is a perspective view of a vehicle, according to another exemplary embodiment.

FIG. 3B is a perspective view of a vehicle, according to another exemplary embodiment.

FIG. 4 is a schematic block diagram of the vehicles of FIGS. 3A and 3B, according to an exemplary embodiment.

FIG. 5 is another schematic block diagram of the vehicle of FIG. 1, according to an exemplary embodiment.

FIG. 6 is a schematic block diagram of a fleet monitoring and control system including a plurality of the vehicles of FIGS. 1, 3A, and 3B, according to an exemplary embodiment.

FIG. 7 is a schematic view of the counterweight system of FIG. 2, according to an exemplary embodiment.

FIG. 8A is a schematic diagram of the counterweight system of FIG. 2 in a first position, according to an exemplary embodiment.

FIG. 8B is a schematic diagram of the counterweight system of FIG. 2 in a second position, according to an exemplary embodiment.

FIG. 8C is a schematic diagram of the counterweight system of FIG. 2 in a third position, according to an exemplary embodiment.

FIG. 8D is a schematic diagram of the counterweight system of FIG. 2 in a fourth position, according to an exemplary embodiment.

FIG. 8E is a schematic diagram of the counterweight system of FIG. 2 in a fifth position, according to an exemplary embodiment.

FIG. 9 is a is a flow diagram of a method for controlling a counterweight system, according to an exemplary embodiment.

FIG. 10 is a is a flow diagram of a method for proactively controlling a counterweight system, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

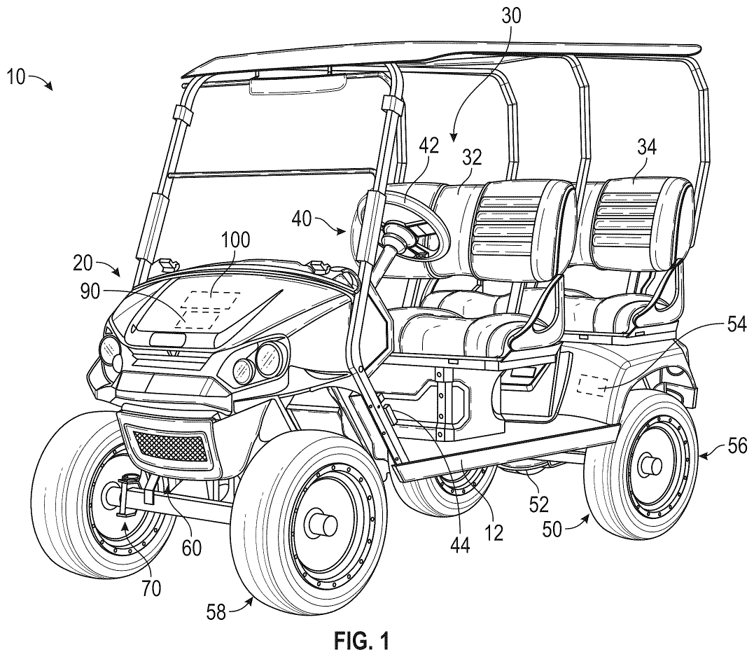

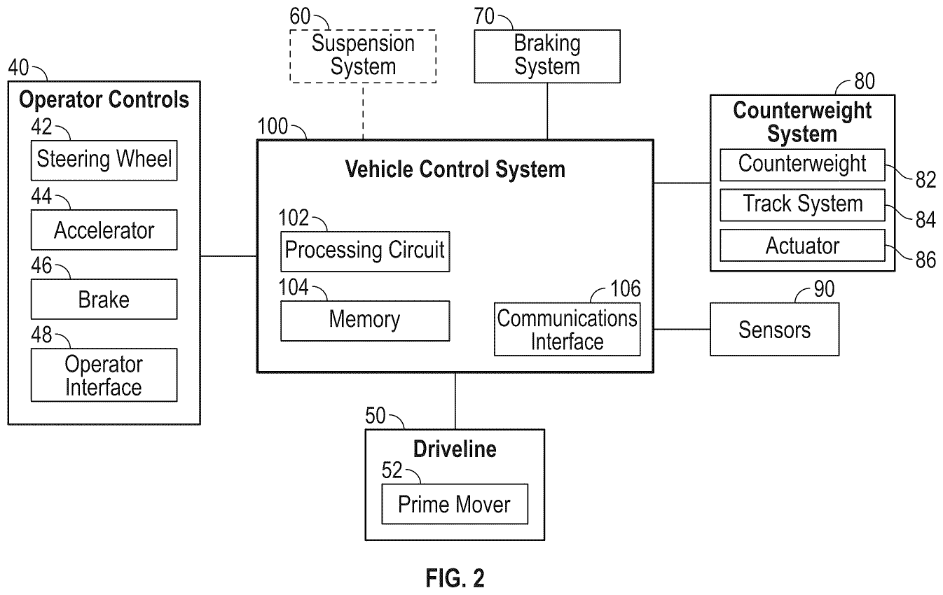

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a stability system, shown as counterweight system 80, one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

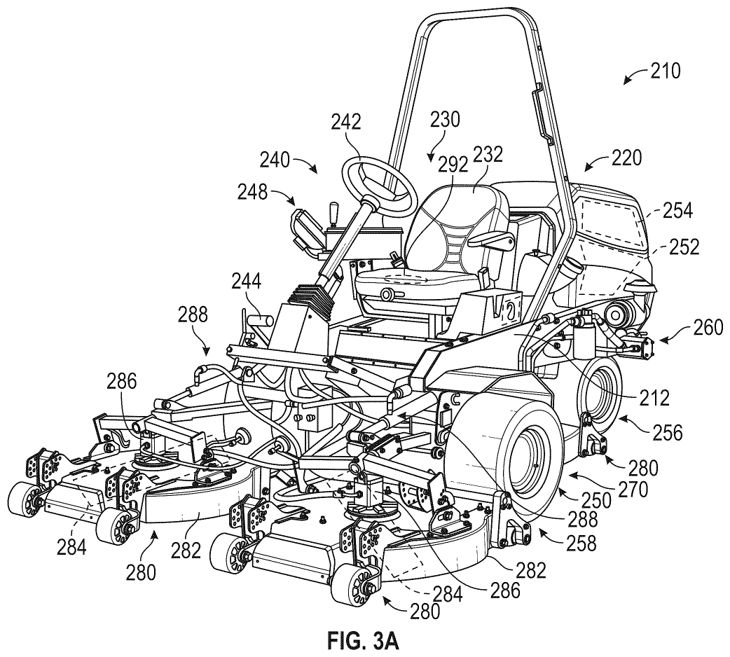

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, a ground support equipment (“GSE”), and/or another type of lightweight or recreational machine or vehicle. In some embodiments, the off-road machine or vehicle is a chore product (e.g., similar to vehicle 210 shown in FIGS. 3A and 3B) such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown as steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

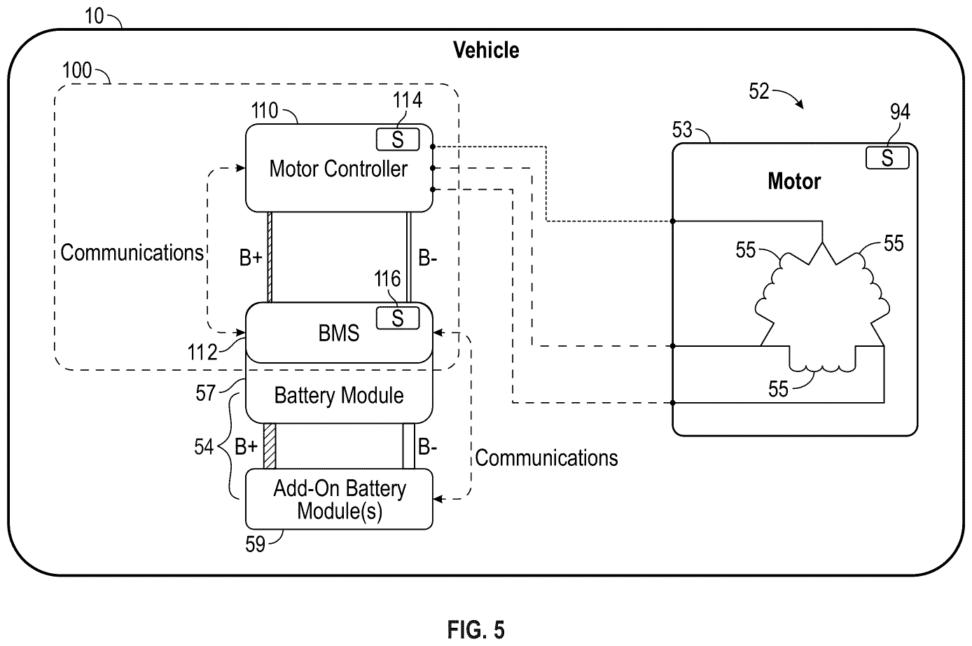

According to an exemplary embodiment, the counterweight system 80 is configured to counteract the effect of terrain slope on the vehicle 10 while the vehicle 10 is in operation. For instance, the counterweight system 80 may be used to prevent the vehicle 10 from tipping or rolling over while in operation. As shown in FIG. 2, the counterweight system 80 includes one or more weights, shown as counterweight 82, a track assembly, shown as track system 84, and a driver, shown as actuator 86. The actuator 86 is configured to manipulate at least one of the counterweight 82 or the track system 84 to reposition the counterweight 82. In some embodiments, the actuator 86 is hydraulically operated. In some embodiments, the actuator 86 is electrically operated. In some embodiments, the counterweight 82 is coupled to and slidable along the track system 84. In some embodiments, the counterweight 82 is fixed to the track system 84 and the track system 84 is manipulated to reposition the counterweight 82. In some embodiments, the counterweight 82 includes a plurality of weights where each of the plurality of weights is coupled to and slidable along the track system 84. By way of example, the plurality of weights may include a first counterweight 82 movable in a lateral direction and a second counterweight 82 movable in a longitudinal direction. The counterweight system 80 is described in greater detail below, with reference to FIGS. 6-10.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, components of the counterweight system 80 (e.g., the counterweight 82, the track system 84, the actuator 86, etc.), and the sensors 90. By way of example, the vehicle control system 100 may send and receive signals (e.g., control signals, location signals, etc.) with the components of the operator controls 40, the components of the driveline 50, the components of the braking system 70, the components of the counterweight system 80, the sensors 90, and/or remote systems or devices (via the communications interface 106 as described in greater detail herein).

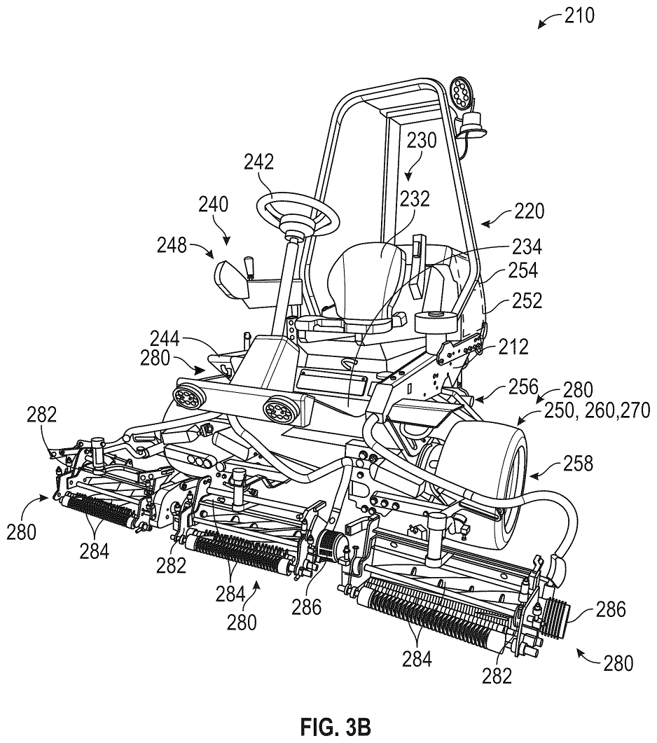

As shown in FIGS. 3A, 3B, and 4, the vehicle 10 is configured as another type of machine or vehicle (e.g., a chore product), shown as vehicle 210, including a chassis, shown as frame 212; a body assembly, shown as body 220, coupled to the frame 212 and having an occupant portion or section, shown as occupant seating area 230; operator input and output devices, shown as operator controls 240, that are disposed within the occupant seating area 230; a drivetrain, shown as driveline 250, coupled to the frame 212 and at least partially disposed under the body 220; a vehicle suspension system, shown as suspension system 260, coupled to the frame 212 and one or more components of the driveline 250; a vehicle braking system, shown as braking system 270, coupled to one or more components of the driveline 250 to facilitate selectively braking the one or more components of the driveline 250; a series of implements, mower assemblies, or cutting units, shown as mower decks 280; one or more sensors, shown as sensors 290; and a vehicle control system, shown as vehicle controller 300, coupled to the operator controls 240, the driveline 250, the suspension system 260, the braking system 270, the mower decks 280, and the sensors 290. In other embodiments, the vehicle 210 includes more or fewer components.

According to an exemplary embodiment, the vehicle 210 is an off-road machine or vehicle. As shown in FIGS. 3A and 3B, the vehicle 210 is configured as a mower (e.g., a lawnmower, a turf mower, a push mower, a ride-on mower, a stand-on mower, or another type of mower). In some embodiments, the vehicle 210 is configured as another type of chore product such as aerator, turf sprayer, bunker rake, and/or another type of chore product (e.g., that may be used on a golf course, around a business or college campus, within a municipality, etc.).

According to the exemplary embodiments shown in FIGS. 3A and 3B, the occupant seating area 230 includes a single seat, shown as driver seat 232. In some embodiments, the occupant seating area 230 includes additional seats (e.g., a passenger seat, an additional row of seats, etc.). According to the exemplary embodiments shown in FIGS. 3A and 3B, the driver seat 232 is laterally centered on the body 220 and facing forward. In some embodiments, the driver seat 232 is facing rearward or otherwise positioned. In some embodiments, the occupant seating area 230 is omitted (e.g., the vehicle 210 is configured as a push mower). A portion of the frame 212 defines a platform, deck, or standing area, shown as operator platform 234. The operator platform 234 may extend forward of the driver seat 232 such that the occupant can rest their feet on the operator platform 234 while seated in the driver seat 232. The operator platform 234 may support the occupant as the occupant enters or exits the driver seat 232.

According to an exemplary embodiment, the operator controls 240 are configured to provide an operator with the ability to control one or more functions of and/or provide commands to the vehicle 210 and the components thereof (e.g., turn on, turn off, drive, turn, brake, engage various operating modes, raise/lower a mower deck 280, etc.). As shown in FIGS. 3A, 3B, and 4, the operator controls 240 include a steering interface (e.g., a steering wheel, joystick(s), etc.), shown steering wheel 242, an accelerator interface and/or braking interface (e.g., a pedal, a throttle, etc.), shown as traction pedal 244, and one or more additional interfaces, shown as operator interface 248. The steering wheel 242 may be used by an operator to indicate a desired steering direction of the vehicle 210. The traction pedal 244 may be used to control the speed and direction of travel of the vehicle 210. By way of example, pressing the traction pedal 244 in a first direction may cause the driveline 250 to move the vehicle 210 forward, and pressing the traction pedal 244 in an opposing section direction may cause the driveline 250 to move the vehicle 210 rearward. Returning the traction pedal 244 to a middle or neutral position may cause the braking system 270 and/or the driveline 250 to slow or stop the vehicle 210 or to hold the vehicle 210 in place. Alternatively, the operator interface 248 may include a pair of handles that act as a steering interface and control the driveline 250 in a zero-turn configuration (e.g., a left joystick to control the left side of the driveline 250 and a right joystick to control a right side of the driveline 250). The operator interface 248 may be used to control operation of the mower decks 280 (e.g., changing a cutting speed of a mower deck 280, changing a cutting height of a mower deck 280, etc.). The operator interface 248 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 250 is configured to propel the vehicle 210. As shown in FIGS. 3A, 3B, and 4, the driveline 250 includes a primary driver, shown as prime mover 252, an energy storage device, shown as energy storage 254, a first tractive assembly (e.g., axles, wheels, tracks, differentials, etc.), shown as rear tractive assembly 256, and a second tractive assembly (e.g., axles, wheels, tracks, differentials, etc.), shown as front tractive assembly 258. In some embodiments, the driveline 250 is a conventional driveline whereby the prime mover 252 is an internal combustion engine and the energy storage 254 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 250 is an electric driveline whereby the prime mover 252 is one or more electric motors and the energy storage 254 is a battery system. In some embodiments, the driveline 250 is a fuel cell electric driveline whereby the prime mover 252 is one or more electric motors and the energy storage 254 is a fuel cell (e.g., that stores hydrogen, that produces electricity from the hydrogen, etc.). In some embodiments, the driveline 250 is a hybrid driveline whereby (i) the prime mover 252 includes an internal combustion engine and an electric motor/generator and (ii) the energy storage 254 includes a fuel tank and/or a battery system. According to the exemplary embodiments shown in FIGS. 3A and 3B, the rear tractive assembly 256 includes rear tractive elements and the front tractive assembly 258 includes front tractive elements that are configured as wheels. In some embodiments, the rear tractive elements and/or the front tractive elements are configured as tracks. In some embodiments, the driveline 250 is omitted, and the vehicle 210 is propelled by an operator (e.g., the vehicle 210 is configured as a push mower).

According to an exemplary embodiment, the prime mover 252 is configured to provide power to drive the rear tractive assembly 256 and/or the front tractive assembly 258 (e.g., to provide front-wheel drive, rear-wheel drive, four-wheel drive, and/or all-wheel drive operations). In some embodiments, the driveline 250 includes a transmission device (e.g., a gearbox, a continuous variable transmission (“CVT”), etc.) positioned between (a) the prime mover 252 and (b) the rear tractive assembly 256 and/or the front tractive assembly 258. The rear tractive assembly 256 and/or the front tractive assembly 258 may include a drive shaft, a differential, and/or an axle. In some embodiments, the rear tractive assembly 256 and/or the front tractive assembly 258 include two axles or a tandem axle arrangement. In some embodiments, the rear tractive assembly 256 and/or the front tractive assembly 258 are steerable (e.g., based on an input from the steering wheel 242 and using a steering actuator 259 that controls the orientation of one or more wheels). In some embodiments, both the rear tractive assembly 256 and the front tractive assembly 258 are fixed and not steerable (e.g., employ skid steer operations). By way of example, the driveline 250 may include a hydrostatic transmission that permits independent driving of the left and right sides of the driveline 250.

In some embodiments, the driveline 250 includes a plurality of prime movers 252. By way of example, the driveline 250 may include a first prime mover 252 that drives the rear tractive assembly 256 and a second prime mover 252 that drives the front tractive assembly 258. By way of another example, the driveline 250 may include a first prime mover 252 that drives a first one of the front tractive elements, a second prime mover 252 that drives a second one of the front tractive elements, a third prime mover 252 that drives a first one of the rear tractive elements, and/or a fourth prime mover 252 that drives a second one of the rear tractive elements. By way of still another example, the driveline 250 may include a first prime mover 252 that drives the front tractive assembly 258, a second prime mover 252 that drives a first one of the rear tractive elements, and a third prime mover 252 that drives a second one of the rear tractive elements. By way of yet another example, the driveline 250 may include a first prime mover 252 that drives the rear tractive assembly 256, a second prime mover 252 that drives a first one of the front tractive elements, and a third prime mover 252 that drives a second one of the front tractive elements.

According to an exemplary embodiment, the suspension system 260 includes one or more suspension components (e.g., shocks, dampers, springs, etc.) positioned between the frame 212 and one or more components (e.g., tractive elements, axles, etc.) of the rear tractive assembly 256 and/or the front tractive assembly 258. In some embodiments, the vehicle 210 does not include the suspension system 260.

According to an exemplary embodiment, the braking system 270 includes one or more braking components (e.g., disc brakes, drum brakes, in-board brakes, axle brakes, etc.) positioned to facilitate selectively braking one or more components of the driveline 250. In some embodiments, the one or more braking components include (i) one or more front braking components positioned to facilitate braking one or more components of the front tractive assembly 258 (e.g., the front axle, the front tractive elements, etc.) and (ii) one or more rear braking components positioned to facilitate braking one or more components of the rear tractive assembly 256 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 250 is a hydrostatic transmission that performs braking by using hydraulic motors to oppose movement of the tractive elements.

Referring to FIGS. 3A and 3B, the vehicle 210 includes a series of mower decks 280 (e.g., cutting units). In some embodiments, the mower decks 280 are configured to act as a ballast or a jack to improve stability of the vehicle 210, as described in greater detail herein. That is, raising, lowering, and/or laterally swinging or side-shifting the mower decks 280 create ballast and/or jacking forces, which counter-balance a tipping moment of the vehicle 210 by changing the center of gravity of the vehicle 210 accordingly. Each mower deck 280 includes a deck, housing, or enclosure, shown as housing 282, and a cutting element 284 (e.g., a blade, a flail, a reel, etc.) movably coupled to the housing 282. Specifically, the vehicle of FIG. 3A illustrates a vehicle 210 in which the mower decks 280 each include a cutting element 284 configured as a blade that rotates about a substantially vertical axis. FIG. 3B illustrates an alternative configuration in which the cutting elements 284 are configured as reels that each rotate about a substantially horizontal axis. Except as otherwise specified, the vehicle 210 of FIG. 3A may be substantially similar to the vehicle 210 of FIG. 3B. Accordingly, a description of the vehicle 210 of FIG. 3A may apply to the vehicle 210 of FIG. 3B, except as otherwise specified.

Referring to FIGS. 3A and 3B, the housing 282 may open downward to expose the cutting element 284 to vegetation below the housing 282. A motor or actuator (e.g., an electric motor, a hydraulic motor, etc.), shown as mower motor 286, is coupled to the housing 282 and drives movement (e.g., rotation, oscillation, etc.) of the cutting element 284. While driven by the mower motor 286, the cutting element 284 crushes, mulches, removes, or otherwise trims vegetation beneath the housing 282. Alternatively, the cutting element 284 may be driven by the prime mover 252 (e.g., through a power take off).

The vehicle 210 includes a series of linear actuators or height adjustment actuators, shown as deck actuators 288, each coupled to the frame 212 and to one or more of the mower decks 280. The deck actuators 288 permit control over a height of the corresponding mower deck 280 relative to the frame 212. The deck actuators 288 may set a cutting height of the mower deck 280. The cutting height represents a final height of vegetation that is trimmed by the mower deck 280. The deck actuators 288 may move the mower deck 280 to a travel position above the cutting height, in which the mower deck 280 is moved out of engagement with the vegetation and the ground surface. The travel position may be used when the vehicle 210 is traveling between job sites and/or the user does not wish to be trimming vegetation.

The sensors 290 may include various sensors positioned about the vehicle 210 to acquire vehicle information or vehicle data regarding operation of the vehicle 210, or the location thereof. The sensors 290 may include various sensors positioned about the vehicle 210 to acquire environment data regarding the environment surrounding the vehicle 210. By way of example, the sensors 290 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, an occupant sensor, and/or other sensors to facilitate acquiring vehicle information, vehicle data, or environment data regarding operation of the vehicle 210, the location thereof, and/or the surrounding environment. According to an exemplary embodiment, one or more of the sensors 290 are configured to facilitate detecting and obtaining vehicle telemetry data including position of the vehicle 210, whether the vehicle 210 is moving, travel direction of the vehicle 210, slope of the vehicle 210, speed of the vehicle 210, vibrations experienced by the vehicle 210, sounds proximate the vehicle 210, suspension travel of components of the suspension system 260, and/or other vehicle telemetry data.

As shown in FIG. 3A, the occupant seating area 230 includes one or more occupant sensors, shown as occupant sensors 292, configured to detect whether an operator or passenger is seated or positioned within the occupant seating area 230. In some embodiments, one or more of the occupant sensors 292 are disposed within or underneath the driver seat 232 to facilitate detecting whether an occupant is sitting within the occupant seating area 230. In some embodiments, one or more of the occupant sensors 92 are disposed within a floorboard of the vehicle 210 to facilitate detecting whether an occupant has entered or exited the occupant seating area 230. In some embodiments, one or more of the occupant sensors 292 are cameras, proximity sensors, etc. disposed about the occupant seating area 230 and configured to facilitate detecting the presence of an occupant within the occupant seating area 230 (e.g., machine vision, etc.).

As shown in FIG. 4, the vehicle controller 300 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 4, the vehicle controller 300 includes a processing circuit 302, a memory 304, and a communication interface 306. The processing circuit 302 may include an ASIC, one or more FPGAs, a DSP, circuits containing one or more processing components, circuitry for supporting a microprocessor, a group of processing components, or other suitable electronic processing components. In some embodiments, the processing circuit 302 is configured to execute computer code stored in the memory 304 to facilitate the activities described herein. The memory 304 may be any volatile or non-volatile or non-transitory computer-readable storage medium capable of storing data or computer code relating to the activities described herein. According to an exemplary embodiment, the memory 304 includes computer code modules (e.g., executable code, object code, source code, script code, machine code, etc.) configured for execution by the processing circuit 302. In some embodiments, the vehicle controller 300 represents a collection of processing devices. In such cases, the processing circuit 302 represents the collective processors of the devices, and the memory 304 represents the collective storage devices of the devices.

In one embodiment, the vehicle controller 300 is configured to selectively engage, selectively disengage, control, or otherwise communicate with components of the vehicle 210 (e.g., via the communication interface 306, a controller area network (“CAN”) bus, etc.). According to an exemplary embodiment, the vehicle controller 300 is coupled to (e.g., communicably coupled to) components of the operator controls 240 (e.g., the steering wheel 242, the traction pedal 244, the brake 246, the operator interface 248, etc.), components of the driveline 250 (e.g., the prime mover 252), components of the braking system 270, the mower decks 280, the deck actuators 288, and the sensors 290. By way of example, the vehicle controller 300 may send and receive signals (e.g., control signals, location signals, etc.) with the components of the operator controls 240, the components of the driveline 250, the components of the braking system 270, the sensors 290, and/or remote systems or devices (via the communication interface 306 as described in greater detail herein).

The communications interface 306 facilitates communications (e.g., wired or wireless communications) between the vehicle 210 and other devices (e.g., other vehicles 210, the user sensors 420, the user portal 430, the remote systems 440, etc.). By way of example, the communication interface 330 may be configured to employ one or more types of wireless communications protocols including Bluetooth, Wi-Fi, radio, cellular, internet-of-things (IoT) telemetry, and/or other suitable wireless communications protocols.

### Electrified Driveline

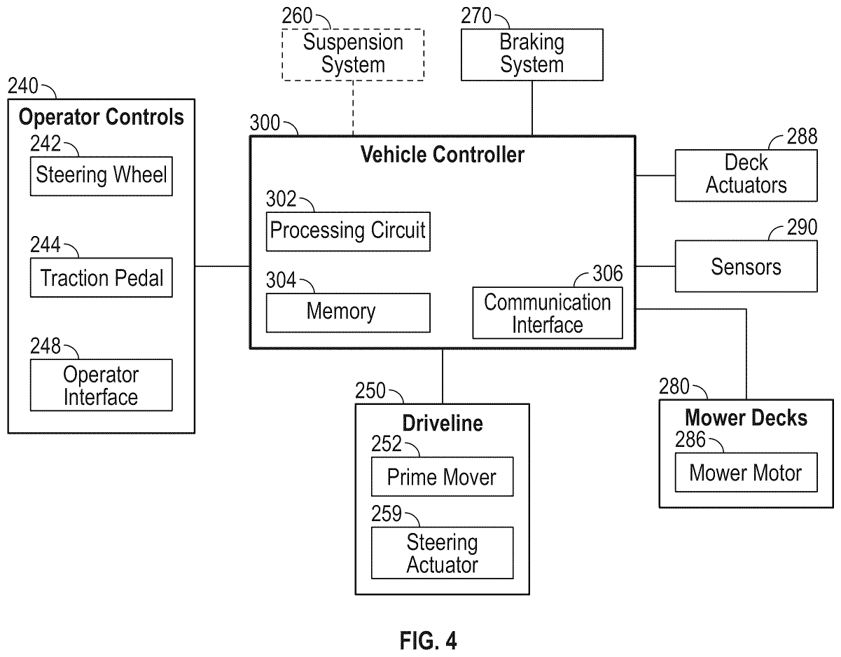

According to the exemplary embodiment shown in FIG. 5, the driveline 50 of the vehicle 10 is configured as an electrified driveline. It should be appreciated that, while the following description is provided in reference to the driveline 50, in some embodiments, the driveline 250 of the vehicle 210 may similarly be configured as an electrified driveline, and the following description of the driveline 50 and various other components of the vehicle 10 may be similarly applicable to the driveline 250 and corresponding components of the vehicle 210.

As shown in FIG. 5, in some embodiments, (a) the prime mover 52 is configured as a three-phase, alternating current (“AC”) electric motor, shown as motor 53, including three sets of windings, shown as motor windings 55, and a first sensor, shown as motor sensor 94; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 94, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 5, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 5, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 440) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

As shown in FIG. 6, a monitoring and control system, shown as fleet monitoring and control system 400, includes one or more vehicles 10 and/or vehicles 210; one or more second sensors, shown as user sensors 420, positioned remote or separate from the vehicles 10 and/or the vehicles 210; an operator interface, shown as user portal 430, positioned remote or separate from the vehicles 10 and/or the vehicles 210; an external or remote user device, shown as user device 432, positioned remote or separate from the vehicles 10 and/or the vehicles 210; and one or more external processing systems, shown as remote systems 440, positioned remote or separate from the vehicles 10 and/or the vehicles 210. The vehicles 10 and/or the vehicles 210, the user sensors 420, the user portal 430, and the remote systems 440 communicate via one or more communications protocols (e.g., Bluetooth, Wi-Fi, cellular, radio, through the Internet, etc.) through a network, shown as communications network 410 (e.g., using the communications interface 106 and/or the communication interface 306). In some embodiments, the site monitoring and control system 400 does not includes the user portal 430 and/or the user device 432.

The user sensors 420 may be or include one or more sensors that are carried by or worn by an operator of one of the vehicles 10 and/or the vehicles 210. By way of example, the user sensors 420 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. In some embodiments, the user sensors 420 include the removeable earpiece 249 to allow for the user to verbally communicate with the vehicle 210 (e.g., the vehicle controller 300), and/or any other component of the system 400 over the network 410. The user sensors 420 may communicate directly with the vehicles 10 and/or the vehicles 210, directly with the remote systems 440, and/or indirectly with the remote systems 440 (e.g., through the vehicles 10 and/or the vehicles 210) as an intermediary).

The user portal 430 may be configured to facilitate operator access to dashboards including the vehicle data, the operator data, information available at the remote systems 440, etc., to manage and operate the site (e.g., golf course, campus, project site, etc.) such as for advanced scheduling purposes, to identify persons breaking course guidelines or rules, to monitor locations of the vehicles 10 and/or vehicles 210, etc. The user portal 430 may also be configured to facilitate operator implementation of configurations and/or parameters for the vehicles 10, the vehicles 210 and/or the site (e.g., setting speed limits, setting geofences, etc.). As shown in FIG. 6, the user portal 430 is accessible via the user device 432. The user device 432 may be or include a computer, laptop, smartphone, tablet, or the like. The user portal 430 and the user device 432 may communicate via one or more communications protocols (e.g., Bluetooth, Wi-Fi, cellular, radio, through the Internet, wired connection, etc.) through a network (e.g., a CAN bus, the communications network 410, etc.). The user device 432 includes a display (e.g., a screen, etc.) configured to display one or more graphical user interfaces (“GUIs”) of the user portal 430.

As shown in FIG. 6, the remote systems 440 include a first remote system, shown as off-site server 450, and a second remote system, shown as on-site system 460 (e.g., in a clubhouse of a golf course, on the golf course, on a campus, on a work site, etc.). In some embodiments, the remote systems 440 include only one of the off-site server 450 or the on-site system 460. As shown in FIG. 6, (a) the off-site server 450 includes a processing circuit 452, a memory 454, and a communications interface 456 and (b) the on-site system 460 includes a processing circuit 462, a memory 464, and a communications interface 466.

According to an exemplary embodiment, the remote systems 440 (e.g., the off-site server 450 and/or the on-site system 460) are configured to communicate with the vehicles 10, the vehicles 210, and/or the user sensors 420 via the communications network 410. By way of example, the remote systems 440 may receive the vehicle data from the vehicles 10 and/or the vehicles 210 and/or the operator data from the user sensors 420. The remote systems 440 may be configured to perform back-end processing of the vehicle data and/or the operator data. The remote systems 440 may be configured to monitor various global positioning system (“GPS”) information and/or real-time kinematics (“RTK”) information (e.g., position/location, speed, direction of travel, geofence related information, etc.) regarding the vehicles 10, the vehicles 210, and/or the user sensors 420. The remote systems 440 may be configured to transmit information, data, commands, and/or instructions to the vehicles 10 and/or vehicles 210. By way of example, the remote systems 440 may be configured to transmit GPS data and/or RTK data based on the GPS information and/or RTK information to the vehicles 10 and/or vehicles 210 (e.g., which the vehicle control systems 100 and/or the vehicle controllers 300 may use to make control decisions). By way of another example, the remote systems 440 may send commands or instructions to the vehicles 10 and/or vehicles 210 to implement.

According to an exemplary embodiment, the remote systems 440 (e.g., the off-site server 450 and/or the on-site system 460) are configured to communicate with the user portal 430 via the communications network 410. By way of example, the user portal 430 may facilitate (a) accessing the remote systems 440 to access data regarding the vehicles 10, the vehicles 210, and/or the operators thereof and/or (b) configuring or setting operating parameters for the vehicles 10 and/or vehicles 210 (e.g., geofences, speed limits, times of use, permitted operators, etc.). Such operating parameters may be propagated to the vehicles 10 and/or vehicles 210 by the remote systems 440 (e.g., as updates to settings) and/or used for real time control of the vehicles 10 and/or vehicles 210 by the remote systems 440.

### Automatic Shifting Counterweight

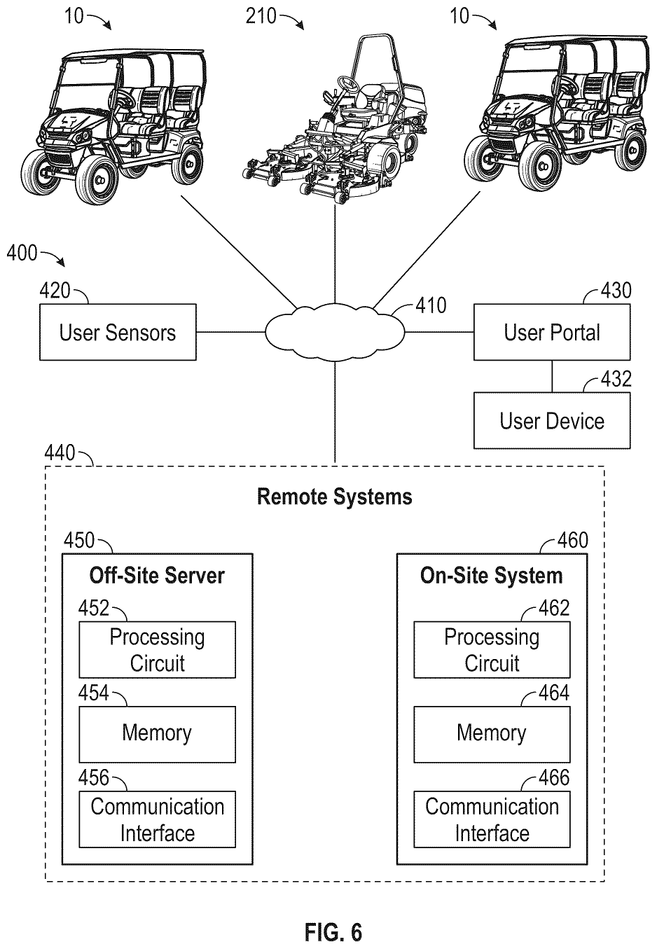

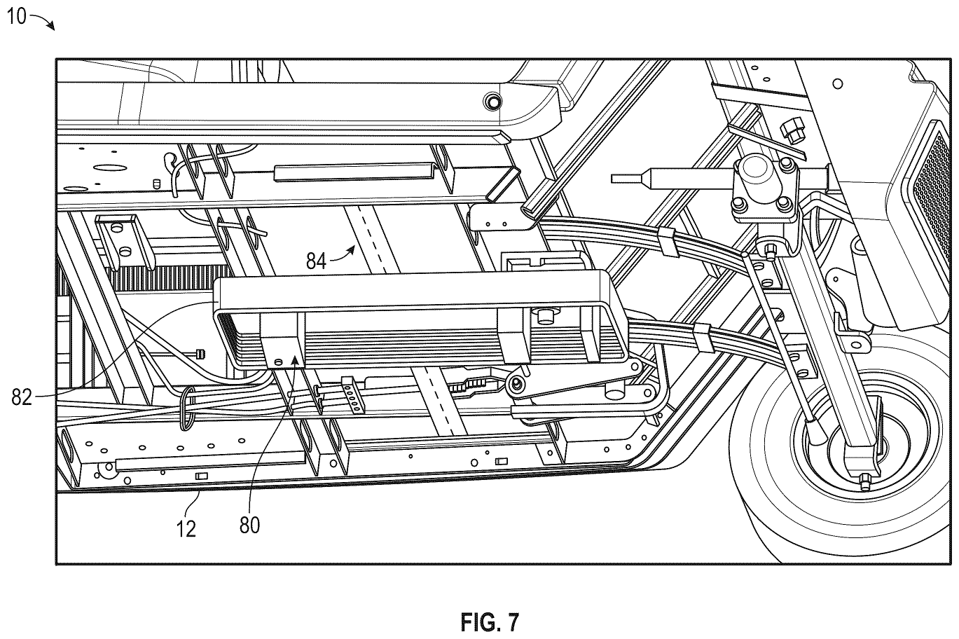

According to an exemplary embodiment, the vehicle 10 and/or the vehicle 210, including the counterweight system 80 and/or the mower decks 280, the sensors 90 and/or the sensors 290, the vehicle control system 100 and/or the vehicle control system 300, etc., is configured to provide stability control by automatically shifting a position of the counterweight 82 and/or the mower decks 280. As shown in FIGS. 7-8E, the counterweight system 80 is coupled to the vehicle 10. More specifically, as shown in FIGS. 7-8E, the track system 84 is coupled to the frame 12 beneath a floorboard of the vehicle 10 and the counterweight 82 is coupled to the track system 84. In some embodiments and as shown in FIG. 7, the track system 84 is configured to extend laterally (e.g., left-to-right) across the frame 12. According to such embodiments, the counterweight 82 is configured to move laterally along the track system 84. In some embodiments, the track system 84 is additionally or alternatively configured to extend longitudinally (e.g., front-to-back) along the frame 12. According to such embodiments, the counterweight 82 is configured to move longitudinally along the track system 84.

In some embodiments, as shown in FIGS. 8A-8E, the track system 84 facilitates repositioning the counterweight 82 laterally across the frame 12 and longitudinally along the frame 12. By way of example, the track system 84 may include or be a X-Y table, with the counterweight 82 coupled or fixed to the X-Y table such that the counterweight 82 is repositionable (e.g., by the actuator 86) laterally and longitudinally in an X-Y plane. FIGS. 8A-8E depict various positions of the counterweight 82 positioned with respect to the vehicle 10, for example in a left-center position, a right-center position, a center-front position, a center position, and a center-back position. Though, it should be understood that the counterweight 82 may be repositioned into any position within the physical movement constraints of the X-Y table in the X-Y plane.

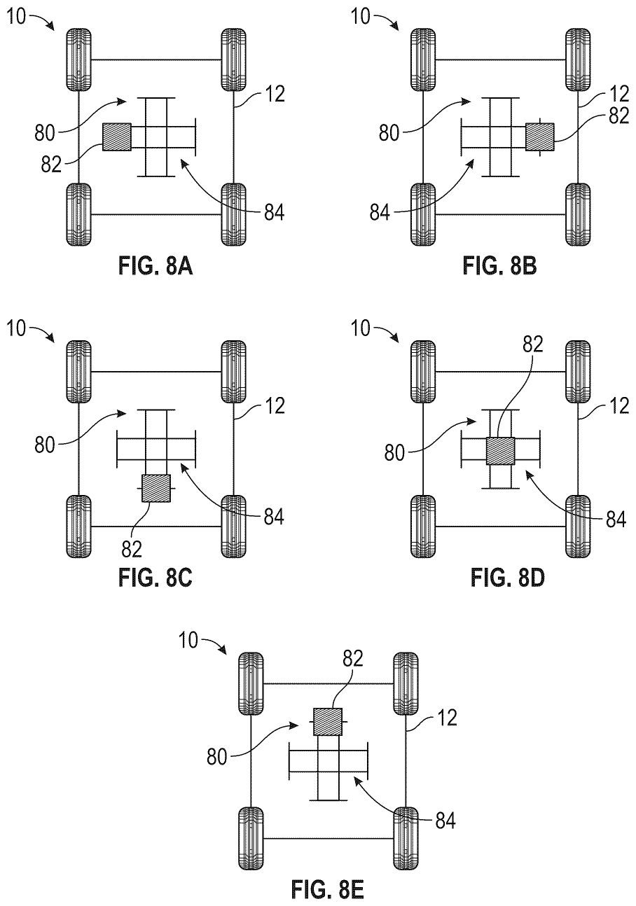

As shown in FIG. 9, a method 500 for controlling the counterweight system 80 and/or the mower decks 280 is shown. In some embodiments, the method 500 is performed by the vehicle controller 100 and/or the vehicle controller 300. At step 505, a control system (e.g., the vehicle controller 100, the vehicle controller 300) is configured to acquire (e.g., detect, record, collect, determine, etc.) data from an IMU coupled to the vehicle 10 and/or the vehicle 210. The IMU may be included in the counterweight system 80 and/or may be one of the sensors 90 and/or the sensors 290, as described above. In some embodiments, the IMU includes a gyroscope and/or an accelerometer. The data acquired from the IMU refers to telemetry data including a position of the vehicle 10 and/or the vehicle 210, whether the vehicle 10 and/or the vehicle 210 is moving, travel direction of the vehicle 10 and/or the vehicle 210, slope of the vehicle 10 and/or the vehicle 210, speed of the vehicle 10 and/or the vehicle 210, acceleration of the vehicle 10 and/or the vehicle 210, vibrations experienced by the vehicle 10 and/or the vehicle 210, sounds proximate the vehicle 10 and/or the vehicle 210, suspension travel of components of the suspension system 60 and/or the suspension system 260, and/or other vehicle telemetry data.

At step 510, the control system is configured to determine an angle of operation of the vehicle 10 and/or the vehicle 210 based on the data acquired from the IMU at step 505. In some embodiments, the angle of operation includes at least one of a pitch angle or a roll angle of the vehicle 10 and/or the vehicle 210. In this way, the angle of operation determined at step 510 may result in a tipping moment.

At step 515, the control system is configured to adjust the counterweight 82 and/or the mower decks 280 based on the angle of operation determined at step 510 to counteract a tipping moment resulting from the angle to increase stability. More specifically, the control system is configured to control the actuator 86 and/or the deck actuator 288 to adjust a position of the counterweight 82 and/or the mower decks 280. Adjusting the position of the mower decks 280 may include (a) vertical movement of the mower decks 280 and/or (b) lateral, swinging, or side-shifting movement of the mower decks 280 resulting in a new or adjusted center of gravity that counteracts the angle of operation (i.e., tipping moment) determined at step 510 such that the mower decks 280 function like movable ballasts. In some instances, the control system may be configured to control the deck actuator 288 to force one or more of the mower decks 280 into engagement with a ground surface to function like jacks or stabilizers to counteract the angle of operation (i.e., tipping moment) determined at step 510 (e.g., if tipping is imminent). In some instances, adjusting the position of the counterweight 82 includes lateral movement of the counterweight 82, longitudinal movement of the counterweight 82, or a combination thereof. Furthermore, where the track system 84 includes the X-Y table described above, adjusting the position of the counterweight 82 at step 515 includes controlling the actuator 86 to manipulate the X-Y table to reposition the counterweight 82 laterally and/or longitudinally in the X-Y plane. Additionally or alternatively, according to embodiments where the counterweight 82 includes the plurality of weights, adjusting the position of the counterweight 82 at step 515 includes adjusting the position (e.g., laterally, longitudinally, etc.) of at least one of the plurality of weights. By way of example, a first counterweight may be repositioned laterally and/or a second counterweight may be repositioned longitudinally.

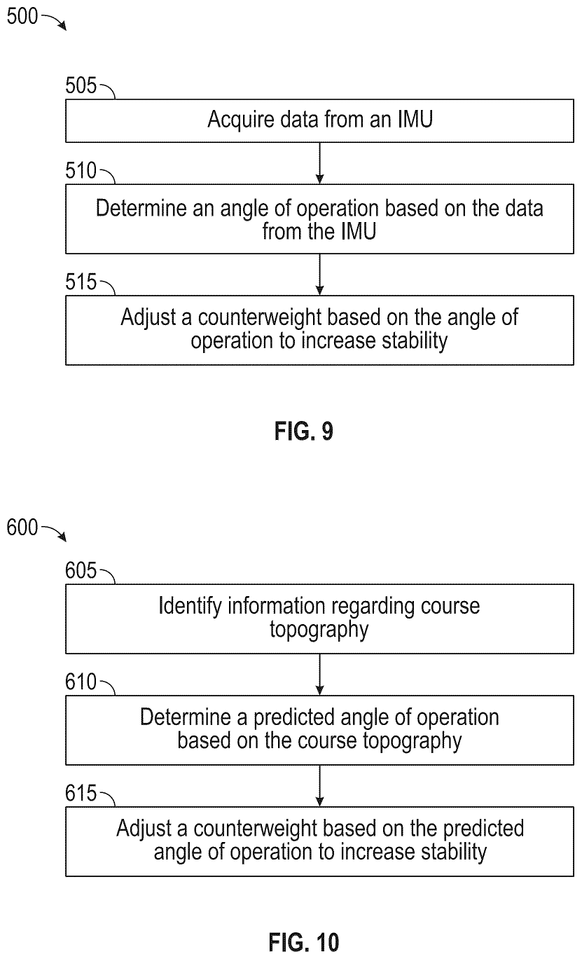

As shown in FIG. 10, a method 600 for proactively controlling the counterweight system 80 and/or the mower decks 280 is shown. In some embodiments, the method 600 is performed by the vehicle controller 100, the vehicle controller 300, and/or the remote systems 240. At step 605, a control system (e.g., the vehicle controller 100, the vehicle controller 300, the remote systems 240, etc.) is configured to identify (e.g., detect, record, receive, determine, etc.) information regarding a topography of a golf course on which the vehicle 10 and/or the vehicle 210 is in operation. In some embodiments, the information regarding the topography includes a slope of the terrain at various points/locations on the golf course. In some embodiments, the information regarding the topography is acquired in real-time with the sensors 90 and/or the sensors 290. In some embodiments, the information regarding the topography is pre-stored (e.g., at the vehicle controller 100, at the vehicle controller 300, at the remote systems 240, etc.). In such embodiments, the location of the vehicle 10 and/or the vehicle 210 may be tracked (e.g., via GPS sensors) and the current and/or upcoming topography may be determined based on the current location of the vehicle 10 and/or the vehicle 210.

At step 610, the control system is configured to determine a predicted angle of operation of the vehicle 10 and/or the vehicle 210 based on the course topography identified at step 605. That is, the control system is configured to predict the angle of operation with which the vehicle 10 and/or the vehicle 210 is expected to operate at a specific point/location of the golf course based on the course topography. In some embodiments, the predicted angle of operation includes at least one of a predicted pitch angle or a predicted roll angle of the vehicle 10 and/or the vehicle 210. In this way, the predicted angle of operation determined at step 610 may result in a predicted tipping moment.

At step 615, the control system is configured to adjust the counterweight 82 and/or the mower decks 280 based on the predicted angle of operation determined at step 610 to counteract a predicted tipping moment expected to result from the predicted angle to increase stability. That is, when the vehicle 10 and/or the vehicle 210 reaches a specific point/location of the golf course, the control system is configured to adjust the counterweight 82 and/or the mower decks 280 based on the predicted angle of operation corresponding to the specific point/location of the golf course. In this way, the control system is configured to proactively position the counterweight 82 and/or the mower decks 280 of the vehicle 10 and/or the vehicle 210, rather than reactively position the counterweight 82 and/or the mower decks 280 based on telemetry data (e.g., acquired at step 505 of method 500). More specifically, the control system is configured to control the actuator 86 and/or the deck actuator 288 to actively adjust a position of the counterweight 82 and/or the mower decks 280.

In some instances, adjusting the position of the mower decks 280 may include (a) vertical movement of the mower decks 280 and/or (b) lateral, swinging, or side-shifting movement of the mower decks 280 resulting in a new or adjusted center of gravity that counteracts the predicted angle of operation (i.e., tipping moment) determined at step 610 such that the mower decks 280 function like movable ballasts. In some instances, the control system may be configured to control the deck actuator 288 to force one or more of the mower decks 280 into engagement with a ground surface to function like jacks or stabilizers to counteract the predicted angle of operation (i.e., tipping moment) determined at step 610 (e.g., if tipping is imminent). In some instances, adjusting the position of the counterweight 82 includes lateral movement of the counterweight 82, longitudinal movement of the counterweight 82, or a combination thereof. Furthermore, where the track system 84 includes the X-Y table described above, adjusting the position of the counterweight 82 at step 615 includes controlling the actuator 86 to manipulate the X-Y table to reposition the counterweight 82 laterally and/or longitudinally in the X-Y plane. Additionally or alternatively, according to embodiments where the counterweight 82 includes the plurality of weights, adjusting the position of the counterweight 82 at step 615 includes adjusting the position (e.g., laterally, longitudinally, etc.) of at least one of the plurality of weights. By way of example, a first counterweight may be repositioned laterally and/or a second counterweight may be repositioned longitudinally. In some embodiments, the control system is configured to proactively position the counterweight 82 and/or the mower decks 280 based on the predicted angle of operation and reactively position the counterweight 82 and/or the mower decks 280 based on the telemetry data (e.g., acquired at step 505 of method 500, fine tune or minor adjustments, etc.), as needed.

As utilized herein with respect to numerical ranges, the terms “approximately,” “about,”“substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the counterweight system 80, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle comprising:
a chassis;
a plurality of tractive assemblies coupled to the chassis;
a prime mover configured to drive one or more of the plurality of tractive assemblies;
an inertial measurement unit (IMU);
a stability system including:
a track system coupled to the chassis;
a counterweight coupled to the track system; and
an actuator configured to manipulate at least one of the counterweight or the track system to reposition the counterweight; and
a control system configured to:
acquire telemetry data from the IMU;
determine an angle of operation of the golf vehicle based on the telemetry data; and
control the actuator to adjust a position of the counterweight based on the angle of operation of the golf vehicle to increase stability.

2. The golf vehicle of claim 1, wherein the golf vehicle is a golf cart, an all-terrain vehicle, a utility task vehicle, a low speed vehicle, a lightweight or recreational vehicle, a mower, an aerator, a turf sprayer, or a bunker rake.

3. The golf vehicle of claim 1, wherein the angle of operation includes at least one of a pitch angle or a roll angle of the golf vehicle.

4. The golf vehicle of claim 1, wherein the counterweight is slidable along the track system, and wherein adjusting the position of the counterweight includes lateral movement of the counterweight along the track system.

5. The golf vehicle of claim 1, wherein the counterweight is slidable along the track system, and wherein adjusting the position of the counterweight includes longitudinal movement of the counterweight along the track system.

6. The golf vehicle of claim 1, wherein the track system includes an X-Y table, wherein the counterweight is fixed to the X-Y table, and wherein adjusting the position of the counterweight includes controlling the actuator to manipulate the X-Y table to reposition the counterweight laterally and longitudinally in an X-Y plane.

7. The golf vehicle of claim 1, wherein the counterweight includes a plurality of weights, and wherein adjusting the position of the counterweight includes adjusting the position of at least one of the plurality of weights.

8. The golf vehicle of claim 1, wherein the IMU includes a gyroscope.

9. The golf vehicle of claim 1, wherein the actuator is hydraulically operated.

10. The golf vehicle of claim 1, wherein the actuator is electrically operated.

11. The golf vehicle of claim 1, wherein the control system is configured to control the actuator to adjust the position of the counterweight based on the angle of operation to counteract a tipping moment resulting from the angle of operation.

12. A stability system for a vehicle, the stability system comprising:
a track system configured to couple to the vehicle;
a counterweight coupled to the track system;
an actuator configured to manipulate at least one of the counterweight or the track system to reposition the counterweight; and
a non-transitory computer-readable medium having instructions stored thereon that, when executed by one or more processors, cause the one or more processors to:
acquire telemetry data from an inertial measurement unit (IMU) for the vehicle;
determine an angle of operation of the vehicle based on the telemetry data; and
control the actuator to adjust a position of the counterweight based on the angle of operation of the vehicle to increase stability.

13. The stability system of claim 12, wherein the counterweight is slidable along the track system, wherein the track system is configured to extend laterally across the vehicle, and wherein adjusting the position of the counterweight includes lateral movement of the counterweight along the track system.

14. The stability system of claim 12, wherein the counterweight is slidable along the track system, wherein the track system is configured to extend longitudinally along the vehicle, and wherein adjusting the position of the counterweight includes longitudinal movement of the counterweight along the track system.

15. The stability system of claim 12, wherein the track system includes an X-Y table, wherein the counterweight is fixed to the X-Y table, and wherein adjusting the position of the counterweight includes controlling the actuator to manipulate the X-Y table to reposition the counterweight laterally and longitudinally in an X-Y plane.

16. A method comprising:
acquiring telemetry data from an inertial measurement unit (IMU) of a vehicle;
determining an angle of operation of the vehicle based on the telemetry data; and
controlling an actuator to adjust a position of a counterweight of the vehicle based on the angle of operation of the vehicle to counteract a tipping moment resulting from the angle of operation.

17. The method of claim 16, wherein the counterweight and the actuator are part of a stability system of the vehicle, wherein the stability system further comprises a track system coupled to the vehicle, and wherein the counterweight is coupled to the track system.

18. The method of claim 16, wherein the counterweight includes one or more mower decks of the vehicle.

19. The method of claim 16, further comprising:
identifying information regarding a topography of a golf course on which the vehicle is in operation;
determining a predicted angle of operation based on the topography; and
controlling the actuator to adjust the position of the counterweight of the vehicle based on the predicted angle of operation to preemptively counteract the tipping moment.

20. The method of claim 19, wherein the topography is prestored and the information regarding the topography is determined based on a location of the vehicle, or wherein the method further comprises monitoring, using one or more sensors of the vehicle, the topography proximate the vehicle in real-time.
